(19) United States
(12) Patent Application Publication
(10) Pub. No.: US 2012/0284281 A1
(43) Pub. Date: Nov. 8, 2012

(54) String And Methods of Generating Strings

(75) Inventors: Charles A. Meyer, Irving, TX (US); Jason A. Snyder, Hoboken, NJ (US); Kerry F. Gunther, Bethesda, MD (US); Patrick G. Peak, Bethesda, MD (US)

(73) Assignee: GOPOGO, LLC, Irving, TX (US)

(21) Appl. No.: 13/274,068

(22) Filed: Oct. 14, 2011

Related U.S. Application Data
(60) Provisional application No. 61/483,373, filed on May 6, 2011.

(51) Int. Cl. G06F 17/30

(52) U.S. Cl. 707/743; 707/E17.014

(57) ABSTRACT

A system for generating a string based upon a plurality of places and a relationship between two or more of those places. Of the plurality of places used in any given string, at least one of the places does not have associated entity related information (e.g., business hours, description of services, etc.). The strings represent an authentic user experience of a quality, character, and/or feel intended by the string author. The user experience can be further enhanced or guided through a narrative accompanying the string or places, written by the string author, that describes or invokes the quality, character or feel of the experience intended by the author.

### RELATED APPLICATION DATA

This application claims the benefit of priority of U.S. Provisional Patent Application Ser. No. 61/483,373, filed May 6, 2011, and titled “Geo-Location Based Playlist System and Method,” which is incorporated by reference herein in its entirety.

### FIELD OF THE INVENTION

The present invention generally relates to the field of web-based social interaction systems and methods. In particular, the present invention is directed to generation of a string of geolocatable activities that is intended to recreate the experience of the author. The string is provided to a user using a computing device, wherein the activities of the string having a relationship to each other.

### BACKGROUND

The ability to share various pieces of information between individuals has increased dramatically in the digital age with the advent of various devices and computer programs that allow for near real-time knowledge about an individual's activities and whereabouts. While the information shared by authors using these computer-based social media websites may be distributed widely, the information is often fragmented and disjointed, robbing authors and receivers of the information of a more complete understanding of the experience the author is attempting to communicate.

Various websites adapted for use in connection with computers allow users to search and locate activities and places of interest. In some cases, a computer may be used in conjunction with a web-based mapping system having geolocation capabilities that may provide a display of activities (e.g., a movie) or places (e.g., a restaurant) of interest. Many known websites search for, and locate, activities of interest when a static query is initiated by the user. Recommendations from this static query may be selected based on geographic proximity to the location of the user.

For example, the Facebook® system allows users to periodically update a profile status, which may include a statement of current thoughts, an article the user is reading, the current location of the person, pictures the person has taken, and so forth. Facebook allows users to connect with other persons to create a social network, the other persons being able to view and comment on the profile status of the user. The user also receives the commentary of others in his or her network in time-sequence, thereby placing the most recent content of a person in the user's network as the first item to be reviewed by the user. The structure and organization of Facebook thereby allow for a review of a recent activity of a person by others, but fail to provide any connection between a multitude of activities of a user, which, when combined, disclose a more detailed and enriching experience.

### SUMMARY OF THE DISCLOSURE

In one implementation, the present disclosure is directed to a geolocation place string building system for use with a computing device. The system includes a computer readable storage medium including a database; a geolocation module configured to permit a user to select coordinates within the database representative of a place; an input module coupled to the geolocation module, wherein the input module initiates the recording of the coordinates responsive to a command from the user; and a string module configured to record a relationship between a plurality of the places identified by the user.

In another implementation, the present disclosure is directed to a method of linking activities into a string presentable to a user using a computing device. The method includes identifying a first place having geolocation coordinates, the first place having a first window; recording the geolocation coordinates of the first place using a computing device; recording a characterization of the first place using the computing device, wherein the characterization includes a description of the first place; identifying a second place having geolocation coordinates that do not have related entity information, the second place having a second window, the first window and the second window selected to create an authentic user experience; recording the geolocation coordinates of the second place using the computing device; recording a characterization of the second place using the computing device, wherein the characterization includes a description of the second place; and generating a relationship between the first place and the second place using the computing device.

In still another implementation, the present disclosure is directed to a method of linking activities into a string presentable to a user using a computing device. The method includes receiving a geolocation coordinate of a first place through an information network, the first place having a first window; recording a characterization of the first place provided through the information network, wherein the characterization includes a description of the first place; receiving a geolocation coordinate of a second place through the information network, wherein the second places does not have related entity information, the second place having a second window, and further wherein the first window and the second window are selected to create an authentic user experience; recording a characterization of the second place provided through the information network, wherein the characterization includes a description of the second place; and generating a relationship between the first place and the second place using the computing device.

In yet another implementation, the present disclosure is directed to a method of linking activities into a string presentable to a user using a computing device. The method includes identifying a first place having geolocation coordinates; recording the geolocation coordinates of the first place with a computing device by using at least one of a computer executable map program or a search of a searchable database that includes at least one string having the first place; recording a characterization of the first place using the computing device, wherein the characterization includes a description of the first place available; identifying a second place having geolocation coordinates that do not have related entity information; recording the geolocation coordinates of the second place with a computing device by using at least one of a computer executable map program or a search of a searchable database that includes at least one string having the second place; recording a characterization of the second place using the computing device, wherein the characterization includes a description of the second place; and generating a relationship between the first place and the second place using the computing device.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic representation of a string generating system (SGS) according to an embodiment of the present invention;

FIG. 1A is a block diagram of an SGS according to an embodiment of the present invention;

FIG. 2 is a block diagram of a taxonomy system according to an embodiment of the present invention;

FIG. 3 is a block diagram of a hierarchical organizational structure for strings according to an embodiment of the present invention;

FIG. 4 is a histogram of string frequency according to an embodiment of the present invention;

FIG. 5 is a flow diagram of a method of generating strings having associated relationships according to an embodiment of the present invention; and

FIG. 6 is a schematic representation of a computer system suitable for use with the SGS according to an embodiment of the present invention.

### DETAILED DESCRIPTION

A string generating system (SGS) of the present invention generates a string based upon two or more places designated by a user, where at least one of the places does not have associated taxonomy or other place or related entity related information (e.g., business hours, description of services, etc.). The string includes a relationship, where the relationship is generated so as to establish a connection between two or more places that, when performed, create or recreate an authentic user experience. This authentic user experience is accomplished through a deliberate selection of two or more places intended to create an experience of a quality, character, and/or feel intended by the string author when the places are visited in temporal proximity to one another. The user experience may be further enhanced or guided through a narrative accompanying the string or places, written by the string author, that describes or invokes the quality, character or feel of the experience intended by the author.

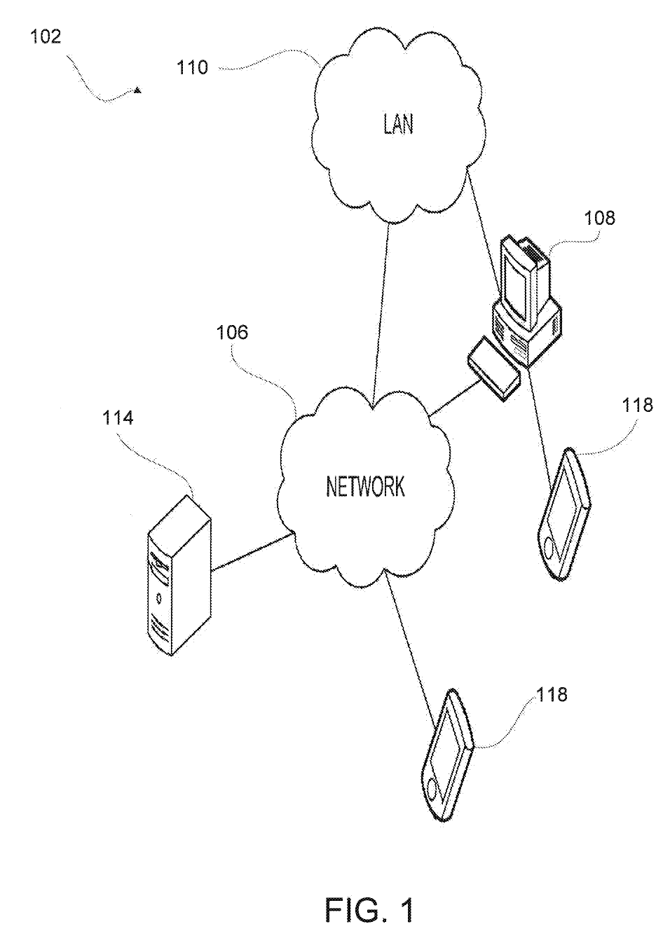

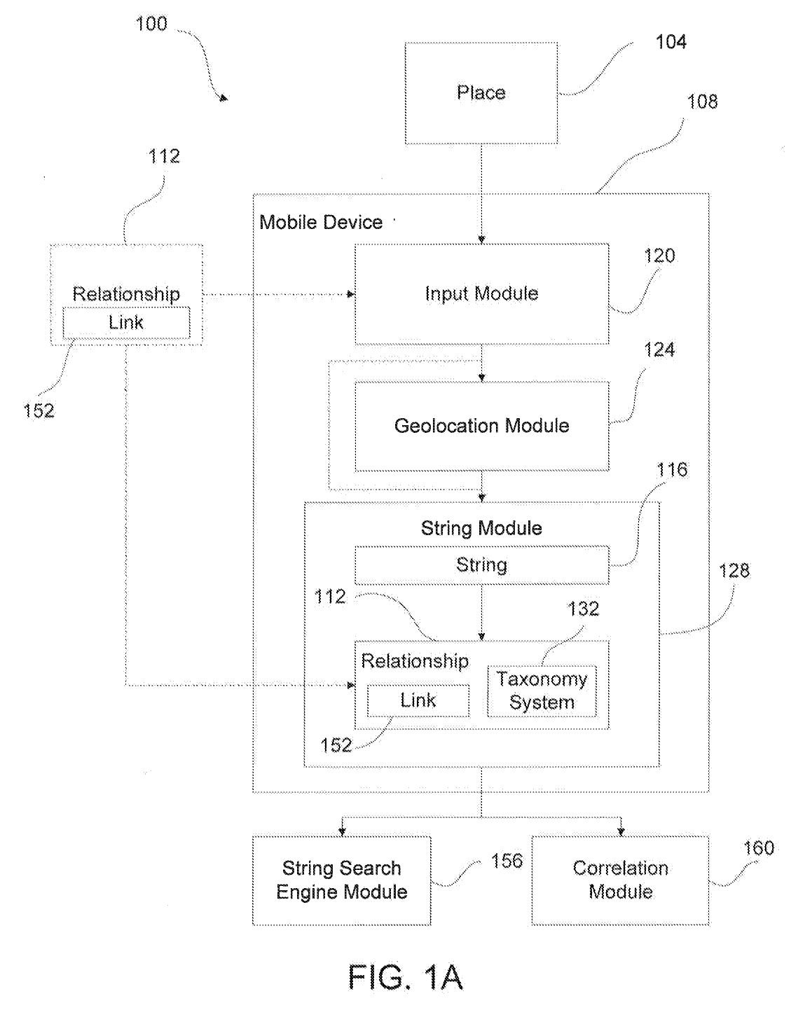

Turning now to the figures, FIG. 1 schematically illustrates an embodiment of a string system building 102 used to identify, communicate, select, and otherwise interact with strings of places used in conjunction with an SGS 100 depicted in FIG. 1A and discussed below. System 102 may be used to communicate a wide variety of information within SGS 100 including, but not limited to user preferences, and user situational factors, including time, date, weather, and user location that can influence the performance of a string 116.

System 102 may include a computing device 108, an information network 106, (such as the Internet), a local area network 110, a content source 114, and one or more mobile devices 118. Computing device 108 may communicate through information network 106 (and/or local area network 110) in order to access string 116 related information in content source 114. Content source 114 can be, for example, a machine readable storage medium, a database, whether publicly accessible, privately accessible, or accessible through some other arrangement such as subscription, that holds string 116 related information, data, programs, algorithms, or computer code, thereby accessible by computing device 108.

As those skilled in the art will appreciate, computing device 108 may take a variety of forms, including, but not limited to, a web appliance, a laptop computer, a desktop computer, a computer workstation, a terminal computer, web-enabled televisions, media players, and other computing devices in communication with information network 106.

Information network 106 may be used in connection with system 102 to enable communication between the various elements of the system. For example, as indicated in FIG. 1, information network 106 may be used by computing device 108 to facilitate communication between content source 114 and the computing device, as well as mobile devices 108. Those skilled in the art will appreciate that computing device 108 may access information network 106 using any of a number of possible technologies including a cellular network, WiFi, wired internet access, combinations thereof, as well as others not recited, and for any of a number of purposes including, but not limited to, those reasons recited above.

SGS 100 may also use information system as discussed in U.S. Provisional Application No. 61/483,373, filed May 6, 2011, and titled “Geo-Location Based Playlist System and Method,” to Meyer, to communicate between modules include with the GSBS. U.S. Provisional Application No. 61/483,373 is incorporated by reference for its discussion of the same. In an embodiment, communication between the modules included with SGS 100 (discussed in detail below with reference to FIG. 1A) may be initiated through a webpage instantiated in a web-based environment existing on a web-page that is accessible through an information network, such as network 106.

Turning now to FIG. 1A, SGS 100 includes one or more software modules configured to allow for the designation of a place 104 by a user via a computing device 108, the generation of strings based upon the places designated by the user, and the assignment of relationships to the strings. As discussed further below, one or more of the modules included with SGS 100 facilitates the input of a designation of place 104 that the user is at, wishes to be at, or has been at before. The location of place 104 may be any geolocatable position, thereby allowing an author to enhance the experience by designating a unique place that is associated with other places the author wishes to include in his or her experience. Two or more of places 104 may then be assembled and be given or attributed a relationship 112, so as to create a string 116. In this way, a user may review, revise, distribute to other connections (e.g., other persons part of the user's social network), allow to be viewed or searched, his or her strings 116 and provide an indication of the relationship associated with the string so as to enrich the experience for the others viewing, editing, or wishing to recreate the string. In an embodiment, string 116 may be considered a social media object, the social media object being communicable between others in the user's social network and/or creating a focal point for others to converge on the string.

In the exemplary embodiment shown in FIG. 1A, SGS 100 includes an input module 120, a geolocation module 124, and a string module 128. Input module 120 allows for inputting data, e.g., place 104, from a user into SGS 100. In this embodiment, when SGS 100 is implemented using computing device 108, which can be, for example, a laptop computer, a desk top computer, a tablet, or other computing device capable of connecting to the Internet, input module 120 permits a user to designate any geolocatable place as a location. A user may select or designate the location using computing device 108 by ways known in the art, such as, but not limited to, touching a spot on a touchscreen, voicing a command, directing a trackball, or using other devices in combination with a computer-based map program. For example, a user may designate the geolocatable place on the map program that is displayed on computing device 108 by moving an indicator of the program to the location of the place on the map, and registering the geolocation by clicking a mouse button, voicing the appropriate command, pressing the touchscreen, or otherwise so indicating that the location is the place of interest using techniques well known in the art. In another example, the user may designate the geolocatable place by searching for the place in a database of existing string. Upon finding a string that contains the place, the user may select place, thereby recording the coordinates.

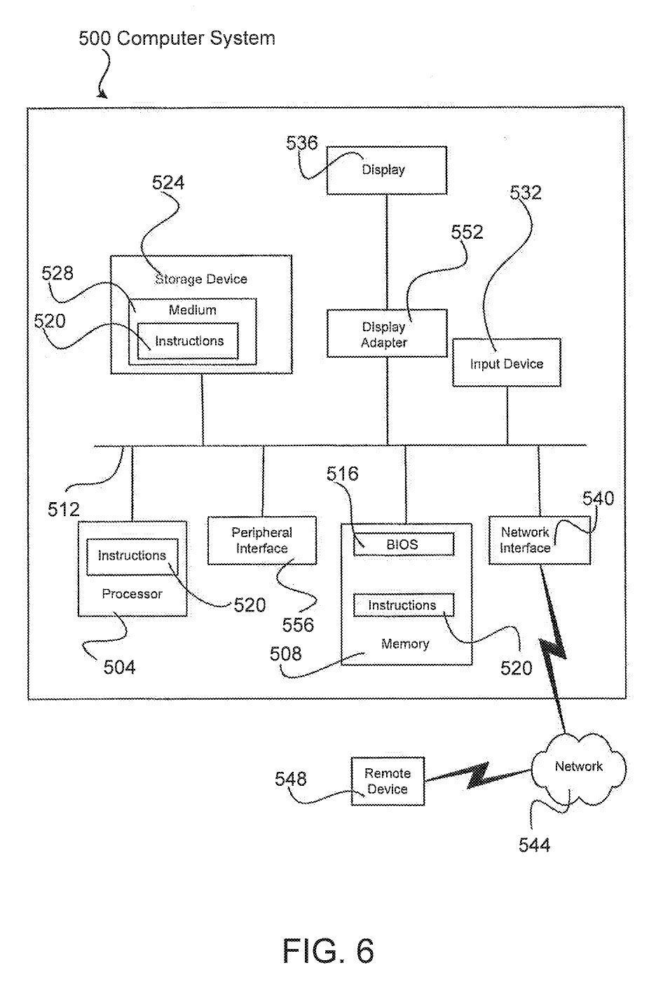

Input module 120 may also allow a user to include other related information to the geolocatable place 104. For example, a user may input a time of arrival at place 104, an experience the user had at the place, the type of event occurring at the place, and the like. A person of ordinary skill in the art should understand that some examples of the aforementioned pieces of related information may be generated automatically when the user designates geolocatable place 104. For example, if the user designates geolocatable place 104 on computing device 108, e.g., by tapping a user interface element (such as a touchscreen displaying a map program) with a command such as “Record This,” the computing device may concomitantly record a time-stamp associated with the designation. The data input by a user into input module 120 may be stored in a database (described further below with reference to FIG. 6) for later retrieval or processing.

Geolocation module 124 is configured to act upon the request of the user, via input module 120, so as to identify and record the location of place 104, which in some embodiments may be a pair of coordinates (i.e., latitudinal and longitudinal) representative of a current, past, or future location of the user, an address of a business, an event location, a website address, or other addressable or geolocatable places. It should be appreciated by those of ordinary skill in the art that location information may be obtained in a number of different ways. For example, location information may be identified using an mapping program, Internet-based or otherwise, IP address of a computer or wireless network, and other known means.

In an embodiment, computing device 108 includes technology for determining an address of an indicated place or ascertaining information associated with the indicated place. Computing device 108 can then communicate that information to another entity, or another entity may retrieve that data from the computing device. When computing device 108 communicates with another device (such as mobile device 118 in FIG. 1), the computing device is associated with identifying information such as addressing information, presence information, and the like. For example, computing device 108 can become associated with an internet protocol (IP) address, a MAC address, a network port, or any number of other types of addressing or locating information. IP addresses, MAC addresses, and others may be analyzed to ascertain information about the location of the computing device 108. Alternatively, computing device 108 can utilize an address associated with an internet service provider, a local area network, and the like.

String module 128 uses as inputs two or more places 104 recorded by geolocation module 124 and may generate or be configured to accept a relationship 112 based on the two or more places so as to develop string 116. Places 104 are connected by relationship 112, which may be articulated by a user or inferred by or transferred to a string module 128, for example, through a global network information system, such as an internet-based webpage. Relationship 112 may include a theme, a narrative, or a trait that is common to places 104 of string 116 or otherwise unites the places so as to produce a cohesive user experience. Some factors that can be used to establish relationship 112 between places 104 of string 116 include, but are not limited to, geolocations of each place 104, the temporal proximity between places, the timeframe associated with the string (total time to visit/access all places in the string), the window of time within which each place must or should be visited, costs associated with each place or with performance of a string in its entirety, a correlation as described in more detail elsewhere within the present disclosure, and/or the narrative supplied with the string that provides a description of the string experience. For example, temporal proximity of places 104 may be a component used to create a quality or type of experience intended by the author of string 116. In another example, temporal proximity can be used to establish relationship 112 between places 104 in the event that one of the places is accessible to users only within a defined period of time. In one embodiment, string 116 entitled “An Afternoon in Asia” could include as place 104 an Asian exhibit at a local museum, followed by a formal tea service at a Japanese tea house. This embodiment of string 116 includes an Asian theme relationship 112 as, optionally described by a narrative, which includes the string title, explaining the connection between the two places 104 and uniting the places through a theme. In this embodiment, places 104 may also share relationship 112 of temporal proximity that is defined by the hours of operation of the museum and the Japanese tea house and have a timeframe such that the user experience of engaging in the two events is further captured.

The connection between the author and a string 116 created by the author can be further enhanced using an author's profile, which in some embodiments, may also provide context and information to assist in forming relationship 112. For example, an author can provide a narrative or description characterizing the author's preferences, persona, profession, activities, age, marital status, home town, neighborhood, hobbies, etc. In another example, an author can use existing online information to provide or inform the profile. Existing online information can include a Facebook® profile, information as to friends, places, comments, and activities extracted from a Facebook account or other similar social media forum. In yet another example, information (including meta-data) from an author's mobile phone, smart phone, or computer can be extracted to contribute to a profile. For example, hobbies, locations of friends and family, and so forth can be extracted based on internet browsing history and phone number data. Once populated and periodically updated, the information in the profile can be used to establish relationship 112.

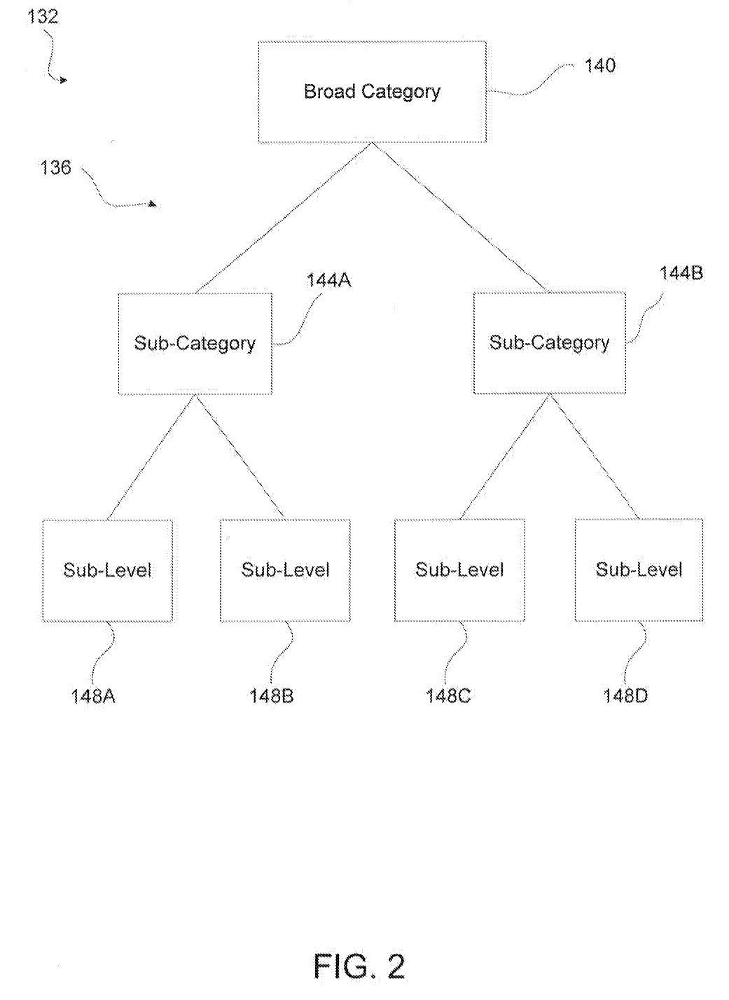

Relationships 112 can further be determined by categorizing traits of places and strings using a taxonomy system 132, shown in FIG. 2. In general, taxonomy refers to terms that may be associated with a place 104. In an embodiment, taxonomy system 132 can be structured to include a number of interrelated and associated category levels 136 that contain pre-defined place classifications. Category levels 136 are related such that a broad level category 140 includes one or more sub-categories 144, with, in certain embodiments, one or more sub-levels 148 disposed thereunder. This structure can be repeated to create a series of successively narrower sub-categories. For example, and as shown in FIG. 2, broad category level 140 could be “stores” with successively narrower sub-categories including “musical equipment stores” (sub-category 144A) with sub-levels including “piano stores” and “antique piano stores,” (sub-levels 148A-B, respectively) and “sports stores” (sub-category 144B) with sub-levels including “racquet sports” and ball sports, (sub-levels 148C-D, respectively). Classifications from broad category 140, any one or more sub-categories 144, or sub-levels 148 can then be assigned to places 104 or strings 116 to characterize the place, relationship 112 between places, or a string. Classifications can also be used to facilitate searching.

In addition to taxonomy, “folksonomy” can be used to develop an organization of places and strings using colloquial terminology and characterizations provided over time by users. In general, folksonomy does not initially include category levels 136, as the terms associated with the place are not predetermined. For example, a folksonomy can develop either through an affirmative solicitation by SGS 100 for characterizations submitted by users or through an examination performed by the SGS of user-provided narratives. In another example, SGS 100 can search for and determine whether multiple users describe or characterize the same place 104 using recurring themes or terms. These recurring themes or terms can then be applied in the same way as a taxonomy 132, and used to describe or classify places 104, strings 116, authors, relationships 112, or the quality of experience.

String 116, as discussed above, includes at least two places 104 having a location. In this context, the term “location” is intended to be defined broadly. That is, and in coordination with geolocation module 124, a location can include any geolocatable place 104. For example, a location can include an address of a physical place, whether a street address, an intersection name, a location identified by a landmark, or a GPS coordinate, also known as a geolocation position.

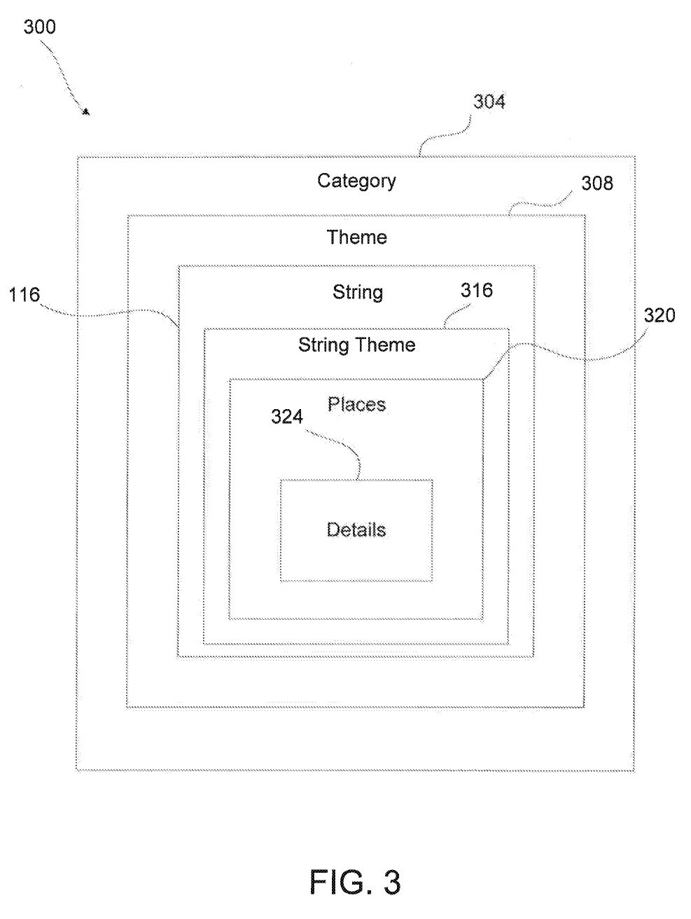

In some embodiments, places 104 and strings 116 can be hierarchically organized under themes and subthemes. FIG. 3 schematically depicts an example of such a hierarchical structure 300 for strings 116. String 116 presented to a user may be organized within one or more categories 304 within hierarchical structure 300. Each category 304 may, in some embodiments, have a unique theme 308 that is common to strings 116 within the category, but differs from the themes of the other categories. In other embodiments, the categories 304 in string 116 may have a similar theme or even the same theme. Similar to the diversity possible between the various categories 304, the strings 116 within a given category may also be distinct from each other while remaining consistent to the theme of the overarching category.

As shown in FIG. 3, each string 116 may include a unique string theme 316, wherein each string theme is consistent with the overarching category theme and the second theme of the hierarchical structure. As mentioned previously, strings 116 may include a plurality of places 320 (which may be places 104), e.g., visiting a garden, dining at a specified restaurant, and watching a show. As with strings 116 within category 304, places 320 may, in some examples, be diverse from each other, but nonetheless consistent with both the first theme of category 304 and the second theme of string 116. In some cases, it may be desirable to associate details 324 with one or more places 320, including, but not limited to, user comments, promotions and special offers, and the ability to invite others to a destination or string 116. As discussed more below, in some cases a user may provide details 324 and in other cases the details may be provided by the entity operating SGS 100. In the former case, for example, a user may add an alternative destination to string 116, through suitable user interface functionality, e.g., input module 120, or a web-based database of places 104 that are searchable and selectable by the user. SGS 100, in one embodiment is structured so that any additions to string 116 added by a user are consistent with the themes of the string 116 and category 304 in which the destination is added. In other embodiments, such limitation may not be desired. Interface functionality in string 116 may also permit a user to rate the string, and rate the author of the string, thereby providing additional information. Other details 324 may also be added to places 316, as those skilled in the art will appreciate.

Returning now to FIG. 1A, each relationship 112 includes one or more links 152. In general, links 152 are specific elements of relationship 116. For example, link 152 can be a temporal link between each place 104 identified in string 116. A temporal link can be important to certain types of strings 116 because the string may need to be completed within a certain time frame in order to properly characterize the user's experience at those places 104 or for other reasons. Additionally, for some strings 116, the sequence of events may require that certain places 104 be visited within a certain window, or windows, of time. For instance, if an exemplary string 116 include three places, such as, a restaurant, a park bench, and a comedy club, and the show at the comedy club has a certain start time, going to the restaurant and then the park bench would require a certain timing so as to afford a re-creator of the string an opportunity to experience the relationship associated with the string. In another embodiment, link 152 may be physical proximity. In yet another embodiment, link 152 may be theme or narrative designated by the user. In a further embodiment, link 152 may be a combination of one or more of the above referenced items.

SGS 100 may also include a string search engine 156. String search engine 156 facilitates the searching of existing strings 116 located in, for example, content source 114 or other database. String search engine 156 may be configured to allow for searching of strings 116 using a variety of different criteria. For example, string search engine 156 may search existing strings 116 by the user who input the string. In another example, string search engine 156 may search existing strings 116 by place 104. In yet another example, string search engine 156 may search existing strings 116 by proximity to a desired location, for instance, if a searcher would like to view all of the strings located near a certain location or destination, e.g., Boston, Mass., Stowe, Vt., etc. In this example, string search engine 156 would return all strings 116 in the locale designated by the searcher. In yet a further example, string search engine 156 may allow a search by places 104 associated with a string 116. In this example, a place of interest would be input into string search engine 156 and the string search engine would return all of those strings 116 that included the place of interest.

SGS 100 may also include a correlation module 160. Correlation module 160 assists in determining various relationships between one or more places 104 designated by a user. In an embodiment of correlation module 160, the correlation module can determine, based upon strings 116, a frequency of occurrence of a sequence of places 104 across multiple strings. The frequency of occurrence can indicate a strong or preferred relationship between two or more places 104.

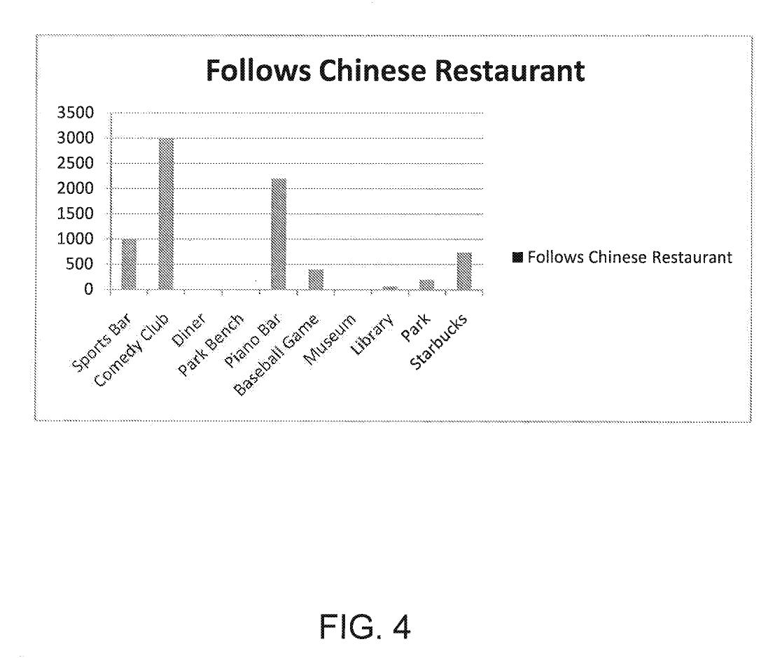

For example, and as shown in FIG. 4, a histogram displays the frequency of strings 116 that have in common at least one place 104, which, in this example, is a Chinese restaurant (the “Chinese restaurant strings”). The other places 104 are, a sports bar, a comedy club, a diner, a park bench, a piano bar, a baseball game, a museum, a library, a park, and a Starbucks® coffee shop. As shown in the histogram in FIG. 4, the comedy club is the most frequently connected activity to the Chinese restaurant. Correlation module 160 allows for this determination, which can subsequently allow for the suggestion of the comedy club to other persons using SGS 100 who may be desiring an experience involving the Chinese restaurant and an additional place 104. Thus, a relationship 112 can be inferred via the use of correlation module 160, which based upon user behavior correlating two or more places 104.

For example, when a user indicates his arrival at a first place 104 (Chinese restaurant) using computing device 108, or when such arrival can be automatically detected, SGS 100 can make correlations using correlation module 160 to point the user to other places based on frequency and temporal proximity data sent by users. As another example, referring to the Asian example discussed above, SGS 100 can correlate the Asian exhibit at the museum with the Japanese tea house based on the frequency of user visits, and the temporal proximity between visits to places 104. This inferred relationship 112 can then be used for a number of purposes, including alerting the user of this previously unrecognized correlation or creating a string that includes the correlated places 104.

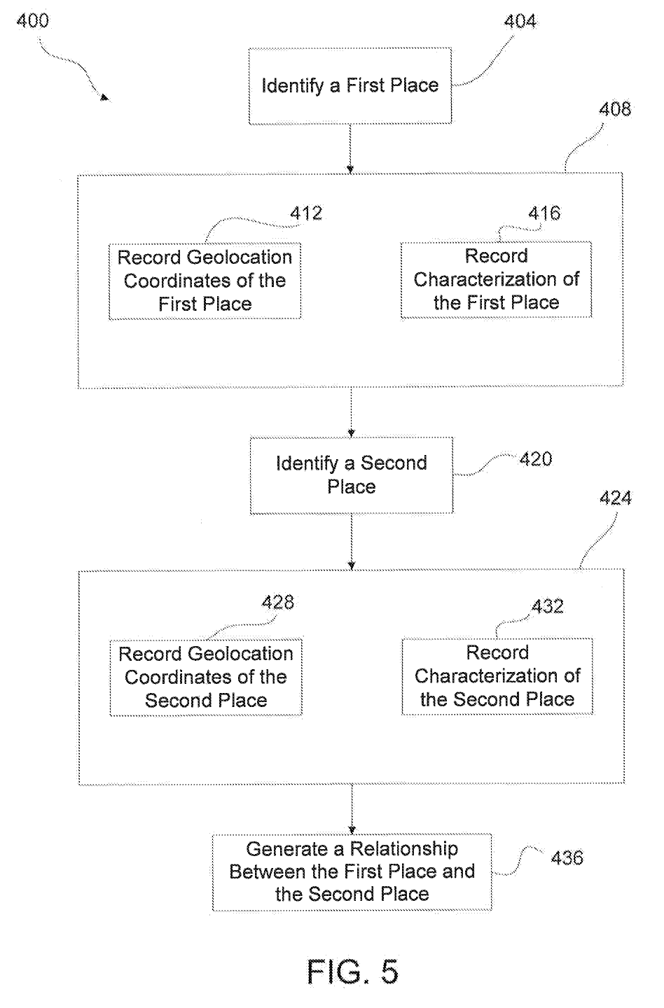

An embodiment of a method of using the example systems described above in the context of FIGS. 1 to 3 is shown in FIG. 5 as method 400. In this example, a first place, e.g., place 104, is identified by a string author at step 404. As described above, an author may identify nearly any type of place, not merely places existing on a list defined by a person or entity other than the user. The first place may be any place having an address or geolocatable position. In an example, the first place has associated with it a time window, which is a time period in which the first place was visited or accessed. The first place may also be described by entity related information. As discussed previously, entity related information may be information that is publically accessible via an information source (e.g., website) about the place. Examples of entity related information may be hours of operation, entity type, entity character, entity services. Because input module 120 is configured to enter geolocation coordinates into a database, and is not limited to a list of establishment or locations provided by a non-user of the method, the field of places that may be assembled into a string is vast.

At meta-step 408, geolocation coordinates of a first place may be recorded within a storage medium (described in more detail below with reference to FIG. 6) at sub-step 412 and the first place may be characterized at sub-step 416. As indicated by the inclusion of steps 412 and 416 within meta-step 408, these sub-steps may be performed in any order without departing from the present disclosure. Characterizing the place at step 416 includes providing a narrative or theme describing the place, providing logistical information that facilitates planning, describing an activity to be performed at the place, associating taxonomic or folksonomic descriptors with the place, or otherwise providing information to establish a relationship or theme that may create an authentic user experience when an activity is performed at the place within the framework of the string. Entering the geolocation coordinates and the characterization of the first place may be entered using the system as described above, or using other systems known to those skilled in the art.

Continuing with method 400, at step 420 a second place is identified as described above at step 404, with the exception that the second place identified is of a type that does not have pre-existing, commercially available entity related information. The second place may include, for example, a park bench, a tree, or a quiet spot along a river. As with the first place, the second place may also include a time window. And, as at meta-step 408, at meta-step 424 the geolocation coordinates may be entered into database using a computing device 108 as described above.

After identifying a second place at step 420, the sub-steps 428 and 432 are performed within meta-step 424 as described above within the context of meta-step 408, and sub-steps 412 and 416. At step 436, a string may be generated by associating the first place with the second place. The string may be generating using the string module of the system described above, or may be generating using other means known to those skilled in the art. Furthermore, those skilled in the art will appreciate that some or all of the steps of method 400 may be repeated so as to generate any number of strings of any number of places.

In an embodiment of process 400, the string generate in step 424 may be further processed. For example, the string may be stored in a database, for example content source 114 or the like, wherein the database suitable for storing tens of thousands, if not millions, of strings or more. This initial string may then be compared to other strings in the database. The comparison may allow for the initial string to be categorized among other strings such that the other strings may be suggested to the author of the initial string. Alternatively, and as discussed above, the comparison may involve determining a frequency of occurrence of the two places or types of relationships that occur.

It is to be noted that any one or more of the aspects and embodiments of process 400 and/or SGS 100, as described herein, may be conveniently implemented using one or more machines (e.g., one or more computing devices that are utilized as a user computing device) programmed according to the teachings of the present specification, as will be apparent to those of ordinary skill in the computer art. Aspects and implementations of SGS 100, discussed above, employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device, mobile device 108) or a portion of the machine and that causes the machine to perform any one of the methodologies and/or embodiments described herein. Examples of a machine-readable storage medium include, but are not limited to, a magnetic disk, an optical disk, a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine and any related information (e.g., data structures and data) that causes the machine to perform any one of the methodologies and/or embodiments described herein.

FIG. 6 shows a diagrammatic representation of one embodiment of control system 112 in the exemplary form of a computer system 500, e.g., computing device 108, within which a set of instructions for causing a processor 504 to perform any one or more of the aspects and/or methodologies, such as process 400, of the present disclosure. It is also contemplated that multiple computing devices, such as computing device 108, or mobile devices or combinations of computing devices and mobile devices may be utilized to implement a specially configured set of instructions for causing SGS 100 to perform any one or more of the aspects and/or methodologies of the present disclosure.

Computer system 500 can also include a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Memory 508 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof.

Computer system 500 may also include a storage device 524, such as, but not limited to, the machine readable storage medium described above. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500, for example using input module 120, via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above.

A user may also input commands and/or other information to computer system 500 via storage device 524 (e.g., a removable disk drive, a flash drive, etc.) and/or network interface device 540. A network interface device, such as network interface device 540 may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network, a telephone network, a data network associated with a telephone/voice provider, a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. In addition to a display device, a computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A geolocation place string building system for use with a computing device, comprising:
a computer readable storage medium including a database;
a geolocation module configured to permit a user to select coordinates within said database representative of a place;
an input module coupled to said geolocation module, wherein said input module initiates the recording of said coordinates responsive to a command from the user; and
a string module configured to record a relationship between a plurality of said places identified by the user.

2. A system according to claim 1, further comprising an correlation engine configured to identify at least one additional place correlated to at least one of said plurality of places based on a frequency of strings containing the at least one additional place and the least one of said plurality of places.

3. A system according to claim 1, wherein said geolocation module is configured to permit a user to select coordinates using a computer executable mapping program.

4. A system according to claim 1, wherein said geolocation module is configured to permit a user to select coordinates by searching for the place in a first string, wherein the first string is previously recorded in the database.

5. A method of linking activities into a string presentable to a user using a computing device, the method comprising:
identifying a first place having geolocation coordinates, the first place having a first window;
recording the geolocation coordinates of the first place using a computing device;
recording a characterization of the first place using the computing device, wherein said characterization includes a description of the first place;
identifying a second place having geolocation coordinates that do not have related entity information, the second place having a second window, said first window and said second window selected to create an authentic user experience;
recording the geolocation coordinates of the second place using the computing device;
recording a characterization of the second place using the computing device, wherein said characterization includes a description of the second place; and
generating a relationship between the first place and the second place using the computing device.

6. A method according to claim 5, wherein said generating a relationship includes geographic proximity.

7. A method according to claim 3, wherein said generating a relationship includes a correlation.

8. A method according to claim 5, wherein said generating a relationship includes visiting the first place within the first window and visiting the second place within the second window, wherein the first window and the second window are selected to create an authentic user experience.

9. A method according to claim 8, wherein said generating a relationship includes performing the string within a time frame.

10. A method according to claim 5, wherein said generating a relationship includes a user provided narrative describing a connection between the first place and the second place.

11. A method according to claim 5, wherein the first place and the second place are identified using at least one taxonomic term.

12. A method according to claim 5, wherein the first place and the second place are identified using at least one folksonomic term.

13. A method of linking activities into a string presentable to a user using a computing device, the method comprising:
receiving a geolocation coordinate of a first place through an information network, the first place having a first window;
recording a characterization of the first place provided through the information network, wherein said characterization includes a description of the first place;
receiving a geolocation coordinate of a second place through the information network, wherein the second places does not have related entity information, the second place having a second window, and further wherein the first window and the second window are selected to create an authentic user experience;
recording a characterization of the second place provided through the information network, wherein said characterization includes a description of the second place; and
generating a relationship between the first place and the second place using the computing device.

14. A method of linking activities into a string presentable to a user using a computing device, the method comprising:
identifying a first place having geolocation coordinates;
recording the geolocation coordinates of the first place with a computing device by using at least one of a computer executable map program or a search of a searchable database that includes at least one string having the first place;
recording a characterization of the first place using the computing device, wherein said characterization includes a description of the first place available;
identifying a second place having geolocation coordinates that do not have related entity information;
recording the geolocation coordinates of the second place with a computing device by using at least one of a computer executable map program or a search of a searchable database that includes at least one string having the second place;
recording a characterization of the second place using the computing device, wherein said characterization includes a description of the second place; and
generating a relationship between the first place and the second place using the computing device.
